(19) United States
(12) Patent Application Publication
(10) Pub. No.: US 2026/0236858 A1
(43) Pub. Date: Aug. 13, 2026

(54) OPTIMIZED REFILL ROUTE PLANNING AND RESOURCE OFFSET CALCULATOR

(71) Applicant: ECOTANK HOLDINGS INC., Orangeville (CA)

(72) Inventors: Robert MAIR, Orangeville (CA); Sean ELLIOTT, Toronto (CA)

(21) Appl. No.: 19/470,906

(22) PCT Filed: May 15, 2024
(86) PCT No.: PCT/CA2024/050651

§ 371 Date: Sep. 30, 2025

Related U.S. Application Data
(60) Provisional application No. 63/502,238, filed on May 15, 2023.

(51) Int. Cl. G06Q 10/047; G06Q 10/0631; G06Q 50/40

(52) U.S. Cl. CPC G06Q 10/047; G06Q 10/0631; G06Q 50/40

(57) ABSTRACT

Systems and methods relating to the determination of locations to be visited in a refill trip as well as the generation of an optimized route for that refill trip. A system gathers data from locations with refillable bulk dispensing containers that dispense product to customers. The fill levels and/or dispense rates for those refillable bulk dispensing containers are determined and fill levels are projected based on the data gathered. Each location's refillable bulk dispensing containers are assessed against criteria for inclusion in a refill list. If the refillable bulk dispensing container conforms to the criteria, then the location for that refillable bulk dispensing container is added to the refill list. Once the list is complete, a routing for the refill trip is determined based on the optimization of one or more parameters for the refill trip. The optimized routing can then be mapped and downloaded to a driver/user's device.

### TECHNICAL FIELD

The present invention relates to the generation of efficient routing. More specifically, the present invention relates to systems and methods for the generation of efficient routing for vehicles that are refilling refillable containers at dispensing locations.

### BACKGROUND

The push for green or environmentally friendly technologies and products has led to an increased demand among consumers for reusable containers. Single use containers, such as jugs for windshield washer fluid are becoming less and less common as consumers opt for refillable options. One consequence of this increased demand is the proliferation of dispensing stations where such refillable containers can be refilled with such products. Previously, bulk dispensing stations for windshield washer fluid were not widely available. Nowadays, they can even be found at fuel stations, EV charging stations, and parking lots.

Because of the proliferation of such dispensing stations the companies that provide such products now have a more difficult time when it comes to refilling the bulk dispensing containers at such dispensing stations. Previously, bulk dispensing containers were generally used in commercial garages and refilling occurred simply by frequency and proximity. As more dispensing stations become available for retail customers, a bulk dispensing market arose. Within this industry, it became apparent that there was a need for an increased focus on efficiency and a desire for less emissions by minimizing the time on the road for the refill trucks. To this end, determining a suitable routing became more important.

This drive for environmentally friendly technologies has also led to a market in resource offsets. Unfortunately, many organizations, especially small organizations that may operate the above noted dispensing locations, are either unaware of or unable to easily take advantage of such credits. There is therefore a need for systems and methods that allow for easy calculation and quantification of resource offsets available to an organization.

In addition to the above, there is also a need for systems and methods that optimize the routing of refill vehicles across multiple dispensing locations in a given area. Preferably, such systems and methods are flexible such that the routing can be generated based on optimizing one or more user selected parameters.

### SUMMARY

The present invention provides systems and methods relating to the determination of locations to be visited in a refill trip as well as the generation of an optimized route for that refill trip. A system gathers data from locations with refillable bulk dispensing containers that dispense product to customers. The fill levels and/or dispense rates for those refillable bulk dispensing containers are determined and refill requirements and/or fill levels are projected based on the data gathered. Each location's refillable bulk dispensing containers are assessed against criteria for inclusion in a refill list. If the refillable bulk dispensing container conforms to the criteria, then the location for that refillable bulk dispensing container is added to the refill list. Once the list is complete, a routing for the refill trip is determined based on the optimization of one or more parameters for the refill trip. The optimized routing can then be mapped and downloaded to a driver/user's device.

In a first aspect, the present invention provides a method for determining locations to be included in a refill trip for refilling fixed refillable bulk dispensing containers at said locations, the method comprising:
determining locations in a specific geographic area;
gathering data for said locations in said specific geographic area;
determining if specific locations conform to specific predetermined listing criteria;
in the event said specific locations conform to said specific predetermined listing criteria, including said specific locations in a refill list;
in the event said specific locations do not conform to said specific predetermined listing criteria, omitting said specific locations from said refill list;
determining routing criteria for use in determining a routing for said specific locations in said refill list;
determining said routing for said trip, said routing being based on at least one of:
   a minimization of a first subset of said routing criteria;
   a maximization of a second subset of said routing criteria;
wherein said routing includes refilling stops at a plurality of said specific locations in said refill list.

In a second aspect, the present invention provides a system for determining locations to be included in a refill trip for refilling fixed refillable bulk dispensing containers at said locations, the system comprising:
a data gathering module for gathering data relating to said refillable bulk dispensing containers at said locations;
a container parameter determination module for determining parameters relating to said refillable bulk dispensing containers, said parameters being based on said data;
a route inclusion module for determining if a specific location is to be included in a refill trip based on said data and on said parameters relating to refillable bulk dispensing containers at said specific location;
a route determination module for determining a route for said refill trip based on at least one of:
   a minimization of a first subset of routing criteria;
   a maximization of a second subset of said routing criteria.

In a third aspect, the present invention provides a method for determining resource offsets based on an amount of product dispensed from refillable bulk dispensing containers, the method comprising:
gathering data relating to refillable bulk dispensing containers at specific locations;
determining parameters relating to said refillable bulk dispensing containers, said parameters being based on said data;
determining a number of disposable containers not used due to a use of said refillable bulk dispensing containers;
determining an amount of non-biodegradable material equivalent to said number of disposable containers;
determining an ecological cost for said amount of non-biodegradable material;
comparing said ecological cost for said amount of non-biodegradable material against an ecological cost for implementing said bulk dispensing containers that dispensed said product to result in a resource offset result;
presenting said resource offset result to a user;
wherein said number of disposable containers is based on said amount of product dispensed from said refillable bulk dispensing containers over a predetermined amount of time, said amount of product dispensed being determined from said parameters.

In a fourth aspect, there is disclosed non-transitory computer readable media having encoded thereon computer readable and computer executable instructions that, when executed, implements a method for determining locations to be included in a refill trip for refilling fixed refillable bulk dispensing containers at said locations, the method comprising:
determining locations in a specific geographic area;
gathering data for said locations in said specific geographic area;
determining if specific locations conform to specific predetermined listing criteria;
in the event said specific locations conform to said specific predetermined listing criteria, including said specific locations in a refill list;
in the event said specific locations do not conform to said specific predetermined listing criteria, omitting said specific locations from said refill list;
determining routing criteria for use in determining a routing for said specific locations in said refill list;
determining said routing for said trip, said routing being based on at least one of:
   a minimization of a first subset of said routing criteria;
   a maximization of a second subset of said routing criteria;
wherein said routing includes refilling stops at a plurality of said specific locations in said refill list.

In a fifth aspect, there is disclosed non-transitory computer readable media having encoded thereon computer readable and computer executable instructions that, when executed, implements a method for determining resource offsets based on an amount of product dispensed from refillable bulk dispensing containers, the method comprising:
gathering data relating to refillable bulk dispensing containers at specific locations;
determining parameters relating to said refillable bulk dispensing containers, said parameters being based on said data;
determining a number of disposable containers not used due to a use of said refillable bulk dispensing containers;
determining an amount of non-biodegradable material equivalent to said number of disposable containers;
determining an ecological cost for said amount of non-biodegradable material;
comparing said ecological cost for said amount of non-biodegradable material against an ecological cost for implementing said bulk dispensing containers that dispensed said product to result in a resource offset result;
presenting said resource offset result to a user;
wherein
said number of disposable containers is based on said amount of product dispensed from said refillable bulk dispensing containers over a predetermined amount of time, said amount of product dispensed being determined from said parameters.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system according to one aspect of the present invention;

FIGS. 2-4 are user interfaces detailing features and parameters which are used by one implementation of the present invention;

FIG. 5 is a flowchart detailing the steps in a method according to another aspect of the present invention;

FIG. 6 is another flowchart detailing the steps in another method according to yet a further aspect of the present invention; and

FIG. 7 is a user interface for use with the carbon credit aspect of the present invention.

### DETAILED DESCRIPTION

For clarity, as should be known to those if skill in the art, for windshield washer fluid, dispensing stations can be placed at locations such as gas stations, garages, fleet operations, parking lots, electric vehicle charging stations, and even convenience stores. Each dispensing station may have one or more refillable bulk dispensing containers from which consumers refill their refillable containers. These refillable bulk dispensing containers are, as their fill levels drop, refilled from refill trucks. The present invention relates to the generation of routing of these refill trucks based on various parameters such as the fill levels of the refillable bulk dispensing containers, the amount of windshield washer fluid that a refill truck can carry, etc., etc.

In one embodiment, the present invention gathers data for each dispensing location at an area. This data is then used to determine parameters relating to the refillable bulk dispensing containers at that location. These parameters can then be used to determine if the location has refillable bulk dispensing containers that need refilling and, hence, if the location needs to be included in the route to be determined. Once the locations to be included in the route have been determined, the route can be optimized such that desirable parameters are either minimized or maximized as preferred.

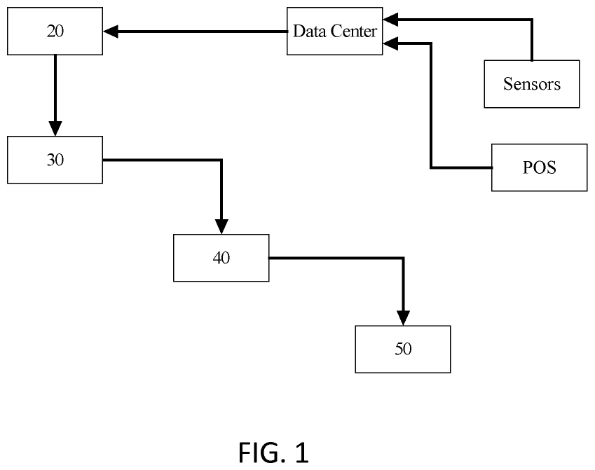

Referring to FIG. 1, a block diagram of a system according to one aspect of the present invention is illustrated. The system 10 includes a data gathering module 20, a container parameter determination module 30, a route inclusion module 40, and a route determination module 50.

In operation, the data gathering module 20 gathers data from each location in a given area. This can be done by having the system access each location's data center and downloading logs relating to the refillable bulk dispensing container. Of course, each refillable bulk dispensing container would be equipped with sensors that would document time stamped fill levels or other data relating to such fill levels. The data from the refillable bulk dispensing container sensors would then be migrated to the location's data center. Alternatively, what may also be present in the data center may be time stamped purchase information (from POS or Point of Sale terminals) that tracks when and how much of the windshield washer fluid was purchased (and dispensed). The logs of the fill levels, the purchase information (or at least the dispensing information) can be downloaded from the data center by the system. Other means of gathering data from each location may, of course, be executed. Data for fill levels of the refillable bulk dispensing containers (and preferably dispensing information) are downloaded so that such data may be used to determine not just time trackable fill levels but usage information.

Once the data from the various locations (and their refillable bulk dispensing containers) have been obtained, these data sets can be used by the container parameter determination module 30. The container parameter determination module determines, depending on the configuration, product usage/dispensing rates, current/projected refillable bulk dispensing container levels, and, with machine learning modules, can even model the usage/dispensing patterns for each refillable bulk dispensing container and/or location. These parameters (and models) can then be used to determine whether each refillable bulk dispensing container and each location needs to be visited so that the refillable bulk dispensing containers can be refilled. It should be clear that the bulk dispensing containers contain product that is dispensed to the public and that this product is refilled as necessary or as desired. In at least some of the implementations detailed in this document, this product is a liquid such as windshield washer fluid.

After each refillable bulk dispensing container's parameters have been determined (as in each refillable bulk dispensing container's projected fill levels or usage/dispensing rates), the route inclusion module 40 determines, for each location, whether each location needs to be included in the projected upcoming refill trip. That is, whether each location's refillable bulk dispensing container(s) conform to a user determined/user configured parameter threshold(s). Depending on configuration, the system may prompt the user for parameters to be used with a threshold which will determine whether to include a location in a refill list. Alternatively, the parameters to be used to determine which locations are to be in the refill list may be preprogrammed into the system. Locations in the refill list will be included in the projected upcoming refill trip. As can be imagined, a number of parameters may be used. As an example, if a refillable bulk dispensing container's fill level is projected to be at or below a specific fill level (with the specific fill level being the threshold), the refillable bulk dispensing container's location may be included in the refill list. For clarity, if the selected parameter for a refillable bulk dispensing container is at or is projected to be at or below a threshold, then that refillable bulk dispensing container is to be added to the refill list. For clarity, the fill level of the bulk dispensing container is tracked in the implementation noted above. However, other implementations may not explicitly track this value but, instead, may track other pieces of data that would indicate that a refill is necessary or desirable.

It should be clear that the usage/dispensing rates may be determined using a machine learning/AI submodule in the container parameter determining module 30. The data and the logs gathered can be used to find the usage/dispensing rate on a, for example, per day basis. Alternatively, instead of a machine learning/AI submodule, a simpler implementation may just use a straight-line projection to determine a usage/dispensing rate. As an example, if, in 10 days, 100 liters of windshield washer fluid has been dispensed, a straight-line projection would show that 10 liters per day is the usage/dispensing rate. Accordingly, if the fill level of a bulk dispensing container is currently at 150 liters and if the refill trip is projected to be in 3 days, then, at a usage/dispensing rate of 10 liters per day, 30 liters of fluid are projected to be dispensed before the projected refill trip. Thus, the refillable bulk dispensing container is projected to have a fill level of (150-30) liters or 120 liters by the projected refill trip.

Of course, if the container parameter determining module includes a machine learning/AI submodule, that submodule may provide different and more complex results. If the submodule, as an example, learns that on weekdays the average usage/dispensing rate is 5 liters a day while on weekends the average usage dispensing rate is 20 liters a day, then this can be taken into account when projecting the refillable bulk dispensing container's fill level. Thus, as an example, if the current fill level of a bulk dispensing container is 150 liters and the projected refill trip is in 3 days with a weekend just before the refill trip, then the projected use will be 1 weekday at 5 liters and 2 weekend days at 20 liters per day. This results in usage of 45 liters by the time the projected refill trip arrives at the location. This means that the projected fill level of the bulk dispensing container is (150-45) liters or 105 liters by the projected refill trip. As noted above, instead of projecting and/or tracking a bulk dispensing container's fill levels, the system may track/project other data that would indicate the need for a refill or when a refill would be desirable.

It should be clear that, in some implementations, the route inclusion module 40 uses the calculated usage/dispensing rates to project each refillable bulk dispensing container's fill levels for a time just prior to the projected upcoming refill trip. If, by the time the projected refill trip arrives, the refillable bulk dispensing container's projected fill level is at or below a given or predetermined threshold, then the route inclusion module 40 includes that refill bulk dispensing container's location in the refill list. In some implementations, the calculated usage/dispensing rates are used to project how many days of fluid are left in the refillable bulk dispensing container. The number of days left can be the parameter with a threshold that determines if a refill bulk dispensing container is to be included in a refill trip. As an example, the threshold may be set at 4 days. If, given the usage/dispensing rate data for a refillable bulk dispensing container, the refillable bulk dispensing container is projected to only have 4 days of fluid left, then that refillable bulk dispensing container is included in the refill list. However, if the refillable bulk dispensing container is projected to have, for example, 5 days left of fluid, this refillable bulk dispensing container may not necessarily be included in the refill list. As should be clear, any projections and/or predictions as to fill levels or a desirability of a refill may be based on when the software of the system is run. In one implementation, if a refill trip is to be undertaken on a Tuesday, the system software can be run on that Tuesday to determine which locations are to be included in the refill trip that is to be implemented on the same day. In another implementation, the system may be configured to project/predict fill levels or other data based on a projected or future refill trip. As can be imagined, in one example, if a refill trip is projected to be on a Friday and the system software is run on a Wednesday, the system software can be configured to project/predict fill levels for the projected Friday refill trip.

As noted above, each location is assessed (based on parameters such as its refillable bulk dispensing container's fill levels) whether the location is to be included in the refill list. Once the refill list has been determined, an efficient and optimized routing for the refill trip is determined by the route determination module 50. For clarity, the optimized routing may be based on optimizing one or more parameters. Such parameters may be predetermined/preprogrammed into the system or the user may be given the option of selecting these parameters. For clarity, optimizing on the basis of one or more parameters may involve maximizing one or more parameters while simultaneously minimizing one or more other parameters.

It should be clear that there are many methods for optimizing based on one or more parameters. One method to generate a route that optimizes a given set of parameters is to select a starting point (e.g. the garage where the refill truck is stored) and then to determine a direct route from that starting point to each of the locations in the refill list. For each of these routes, the values for the parameters to be optimized are determined and the route that has the best values (i.e. the lowest parameter values for the parameters to be minimized or the highest parameters values for the parameters to be maximized) is selected. From the end location of the selected route, a route is then mapped from that end location to each of the rest of the remaining locations in the refill list. The parameter values for each of these routes are, again, determined. The next leg of the route is then selected as the route with, again, the best parameter values. These steps are repeated until all the locations have been visited in the resulting route, with each leg of the route being determined based on the best parameter values calculated. Of course, other considerations may be taken into account, such as the refill capabilities of the refill truck. As an example, if the refill truck can carry 1000 liters of washer fluid, the amount dispensed into each refill bulk dispensing container at each location visited will be subtracted from this carrying capacity of the refill vehicle. By tracking how much washer fluid is projected to be dispensed at each location to be visited, the system can take into account the number of locations that can be visited per refill trip. The number of locations to be visited in a refill trip can be a parameter to be maximized as well as the number of refill bulk dispensing containers refilled.

Suitable optimization submodules can be used with the system and with the route inclusion module in conjunction with a suitable mapping module to track the distances and to calculate/determine routes.

The parameters that may be optimized by maximization include:
number of locations visited in a refill trip;
number of refillable bulk dispensing containers refilled;
amount of fluid dispensed to refill refillable bulk dispensing containers.

The parameters that may be optimized by minimization include:
cost of refill vehicle driver (e.g. the hourly or daily wage of the driver);
cost of fuel for refill vehicle;
fuel used by the refill vehicle (based on a given fuel usage rate by the refill vehicle);

### Distance Travelled by the Refill Vehicle;

time taken to complete a bulk dispensing container refill (based on a predetermined time to refill on a per liter basis)
time taken to drive a refill route on a predetermined speed/travel time for the refill truck) or with live traffic data
distance between locations visited for a refill trip;
time on the road between locations visited for a refill trip (based on a predetermined speed of travel for the refill truck);
cost per km/mile for the refill truck (which may be a combination of multiple parameters);
distance of a location from a starting point (e.g. the starting point could be a refill depot from which the refill truck starts its refill trip);
proximity/distance of a location from other refillable bulk dispensing containers that are on the refill list;
average time to refill a refillable tank (NB: this may be calculated based on a given fill rate for a refill truck and a fill level of the refillable tank and may be based on the projected average time for a given refill trip);
time spent (as an aggregate) refilling refillable bulk dispensing containers on the refill trip.

As noted above, the system may be integrated with a suitable navigation/mapping submodule to thereby provide mapping capabilities. Such a submodule, in conjunction with a suitable app, such as Google Maps™, can map a projected refill trip route and can provide distance, travel time, and routing projections. In addition, such integration with such a suitable navigation/mapping submodule and such a suitable app allows the system to upload the resulting optimized refill trip route (i.e. a refill trip itinerary) to a suitable front-end subsystem or to a user's mobile phone or navigation device.

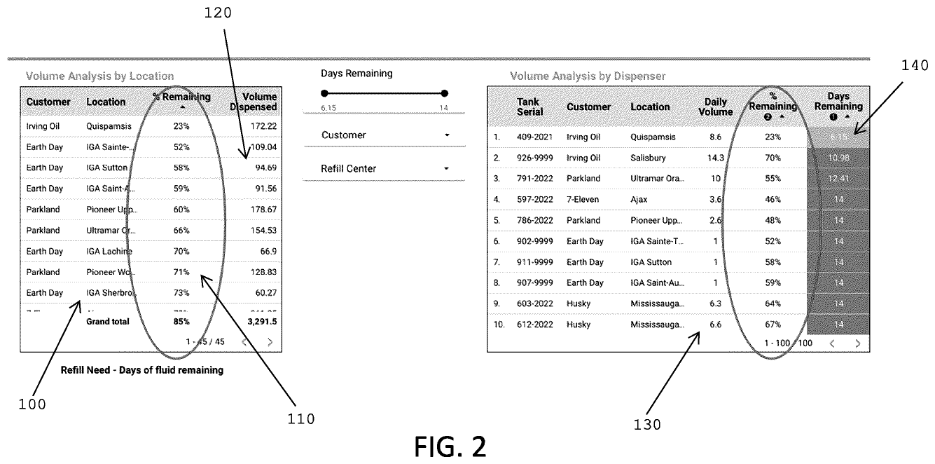

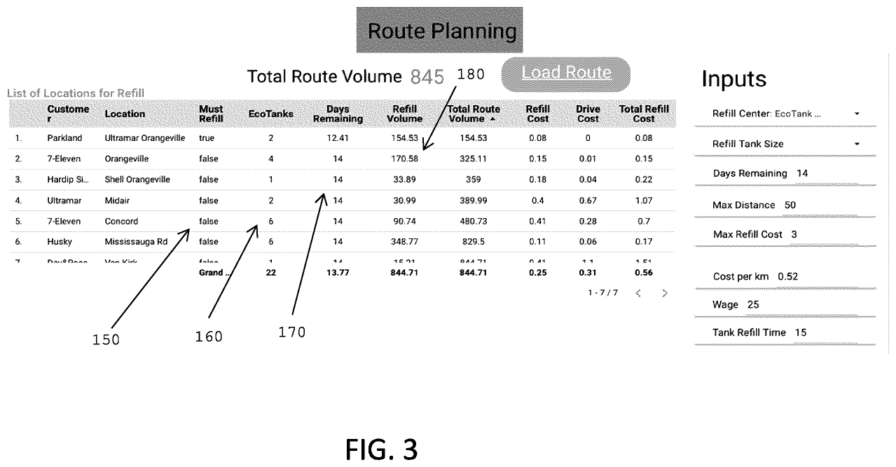

Referring to FIGS. 2-4, example user interfaces of a suitable front-end subsystem used with one implementation of the present invention are illustrated. In FIG. 2, shown are listings of locations 100 and refillable bulk dispensing container fill levels 110. As can be seen, the user interface details a remaining percentage of fill level in each refillable bulk dispensing container at the listed location. The usage 120 for each refillable bulk dispensing container is also detailed. The daily volume dispensed 130 for each refillable bulk dispensing container is also provided, along with a projected number of days 140 of fluid left in each refillable bulk dispensing container. As can be seen, a warning indicator for current fill levels is color coded into the user interface. When the fill level for a specific bulk dispensing container is below a certain level, the user interface indicates this with a yellow background. When the fill level is below an even lower level, a red background is used. And if the fill level is well above these two levels, a green background is used. The color coding simply operates as a visual warning to a user about current fill levels for the bulk dispensing containers illustrated. Referring to FIG. 3, a user interface for optimized route planning is illustrated. As can be seen, the user interface includes, for each location, an indication 150 of whether the location is to be included in a refill list. The MUST REFILL column details whether a location is to be included in the refill list (i.e. an entry of TRUE is in the column) or not (i.e. an entry of FALSE is in the column). Also shown is the number 160 of refillable bulk dispensing containers at each location, how many days 170 of fluid are left for the location, and how much volume 180 of fluid is needed to refill all the refillable bulk dispensing containers at each location. Also provided is a normalized refill cost for each location, a normalized cost for the driver of the refill vehicle, and a total refill cost based on the normalized refill cost and driver cost. It can be seen that a cumulative total of the total route volume is provided for each location in the refill list. The user interface shows the user the total refill volume as each location is added to the refill list.

Interestingly, the user interface in FIG. 3 also shows the total refill cost for each location based on a sum of the normalized refill cost and the normalized driver cost. Once the total refill cost is determined, an average refill cost on a per location basis is provided at the bottom of the table. It should be clear that the normalization of the refill cost and of the driver cost can be performed based on any number of methods and on any number of bases. As an example, the refill cost may be based on a suitable combination of fuel costs, time costs, and predetermined wear and tear costs on the refill vehicle. The driver cost may be based on a set driver wage and on a projected time needed to visit each location on the refill list.

In one implementation, the total refill cost is calculated as, at its base, a combination of driver cost and distance cost. For this implementation, the drive cost is calculated as a function of the marginal cost of adding a location to the refill route and the cost per unit distance driven. This cost calculation may be more sophisticated and precise and may include the cost of fuel, fuel consumption of vehicles, etc. The cost of refill is, in one implementation, the time of the driver to physically refill a new bulk dispensing container added to the refill route.

It should be clear that parameters other than driver cost and distance cost may be used to determine the total refill cost. The choice of parameters to be used may be implementation dependent and may depend on a user's business needs and goals. It should also be clear that the threshold values to be used for the parameters used to determine whether a location is to be included in a refill list may be user configurable. Again, this may be implementation dependent.

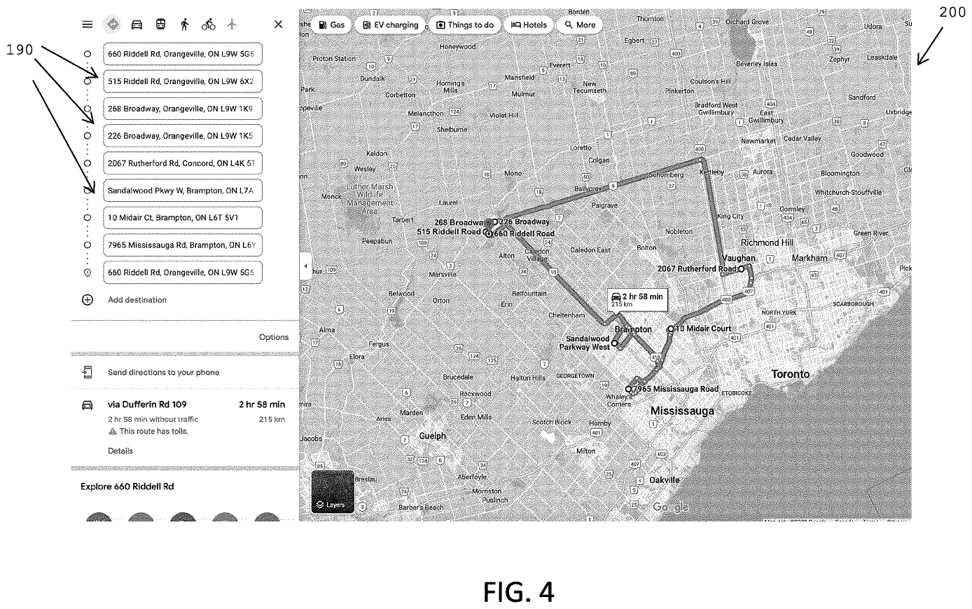

Referring to FIG. 4, illustrated is a user interface that integrates the results of the system analysis and optimized route generation with a mapping/navigation app/interface. As can be seen, an itinerary 190 of different locations to be visited in a projected refill trip is provided. In addition, a map 200 detailing the route to be taken in the refill trip is provided. Also provided in the map is a projected travel time to traverse the refill trip and a projected total distance travelled in the refill trip. The map and the itinerary can be either downloaded and printed or uploaded/forwarded to a user's mobile device for use during the refill trip.

It should also be clear that, in one implementation, optimization is based on minimizing the total refill cost as determined by driver cost and distance cost. To explain the concept, in one example, two bulk dispensing containers are in opposite directions from a location that has been visited. Assuming that both are in equal need of refilling, the system will select a bulk dispensing container for inclusion in the refill list that optimizes or minimizes the driver cost and distance cost for the refill trip. If bulk dispensing container A is farther from a starting point than bulk dispensing container B but a refill trip to bulk dispensing container A is more efficient (as in optimizes the total refill cost) than a refill trip to bulk dispensing container B, then A is selected for the refill trip.

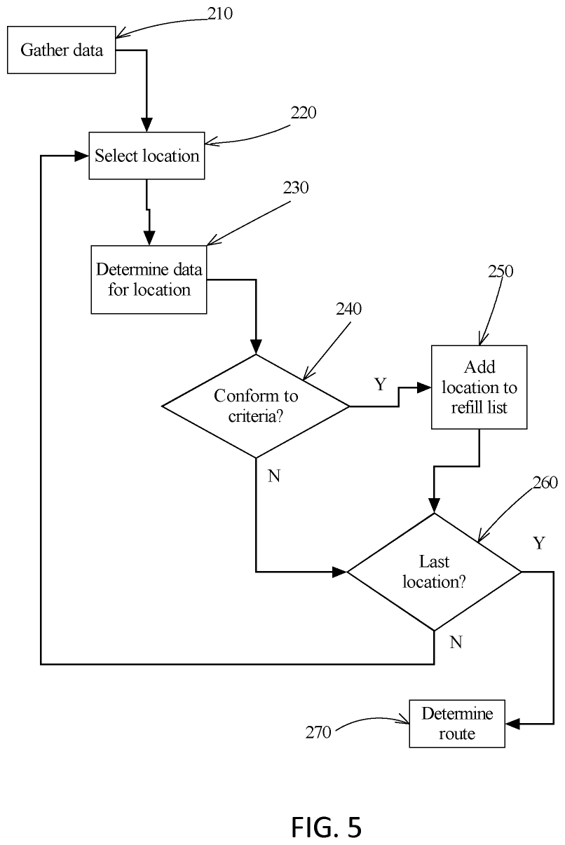

Referring to FIG. 5, a flowchart of a method according to another aspect of the present invention is illustrated. It should be clear that this method assumes that the locations that are assessed are all designated to be refilled from a specific depot or a specific centralized refill center. These locations designated to be serviced or refilled from a given centralized refill center are assessed as to whether they are to be included in a refill list. The method retrieves data from these locations and then the locations are assessed as to whether they are to be in a refill list. The refill route based on the refill list is then optimized based on specific parameters.

The method begins with the gathering of data from data centers for one or more locations that are equipped with refillable bulk dispensing containers (step 210). Once that data from multiple locations have been gathered, the data is processed on a per location basis. A location is first selected (step 220) and the parameters for the various refillable bulk dispensing containers from that location are determined from the gathered data (step 230). Based on the parameters for the various refillable bulk dispensing containers from that location (including fill levels, usage/dispensing rates, etc.), a determination is made as to whether the location conforms to the criteria for including the location at the next/projected refill trip (step 240). If the location conforms to the criteria (which may be predetermined or which may be selected by a user on a per refill trip basis), then the location is added to the refill list (step 250). In the event the location does not conform to the criteria, then the location is not added to the refill list. Regardless of the result of step 240, the logic flow moves on to decision 260, that of whether the location is the last to be assessed. If the location is not the last to be assessed, the logic flow loops to step 220, that of selecting a location.

Once there are no more locations to be assessed and the refill list has been completed, then a route for the refill trip to visit and refill the refillable bulk dispensing containers at the locations is determined. Such a route is based on optimizing one or more parameters (step 270). As is known to those of skill in the art, there are many varied and well-known methods for determining and optimizing such a route.

It should also be clear that the method detailed in FIG. 5 may have a preliminary step of selecting a centralized refill center. This selection then ensures that the locations to be selected and assessed in the steps of the method are only those locations designated to be serviced and/or refilled from that selected centralized refill center.

As noted above, another need relates to resource offsets and how these may be calculated for organizations that may not be aware of their value. In one aspect of the present invention, a system accesses an organization's data center and, by using data relating to how much product has been sold, dispensed, or otherwise provided using refillable containers, an equivalent amount of single use plastic containers not used due to the refillable containers is calculated. This amount is then equated to resource offsets that an organization can then use as an added benefit to having refillable bulk dispensing containers that can dispense product to consumers that use refillable containers.

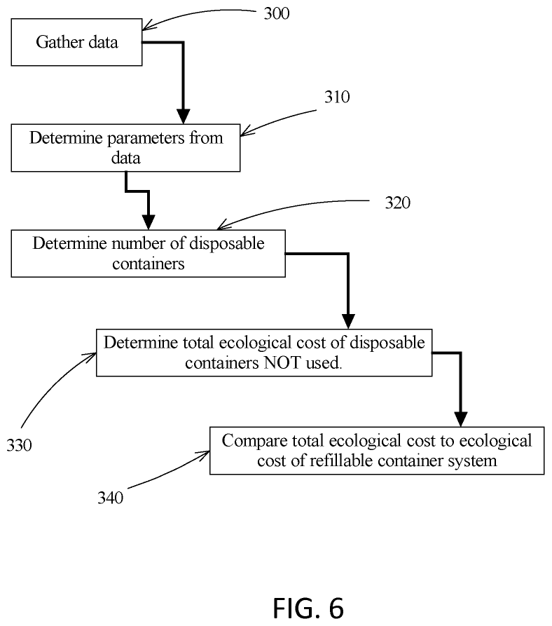

Referring to FIG. 6, a block diagram detailing a method according to another aspect of the present invention is illustrated. The method begins at step 300, that of accessing the data center for multiple locations with one or more refillable bulk dispensing containers. As with the method and system detailed above, the data gathering step may take the form of gathering data from sensors coupled to the refillable bulk dispensing containers or from point of sale (POS) terminals to gather sales data. Step 310 is that of determining parameters for the refillable bulk dispensing containers from the data. This step may include determining how much product has been dispensed from the refillable bulk dispensing containers from either the sales data or from the sensors. This may be done on a per organization basis (i.e., for each company operating the refillable bulk dispensing containers, how much product was dispensed for a given time frame) or on a per location basis (for each location, how much product was dispensed by its refillable bulk dispensing containers in the given time frame).

Once the parameters have been determined, the method then determines how many disposable containers have not been used by the use of the refillable bulk dispensing containers (step 320). This step is based on a given disposable container with a specified and fixed volume and involves the amount of product dispensed for a given time frame (as determined in the previous step). By dividing the amount of product (on a volume basis) by the specified and fixed volume of the given disposable container, the number of disposable containers not used can be determined.

The next step (step 330) is that of determining the ecological cost of producing, transporting, and disposing of this number of disposable containers. Such an ecological cost may include the carbon emissions from the manufacturing, transportation, and disposal of these disposable containers. The determination of the total ecological cost of this number of containers is performed by having a predetermined and fixed ecological cost (on a per container basis) preprogrammed and then multiplying this fixed ecological cost by the number of containers determined in step 320. This multiplication results in a final amount of ecological cost for the disposable containers not used due to the use of the bulk dispensing container system. Of course, the final amount of ecological cost of these non-biodegradable material (e.g., plastic) may be given on a volumetric basis or on a mass/weight basis.

After the final amount has been determined, this is then compared with a predetermined ecological cost based on how much carbon/ecological cost was spent in the setting up/creation of at least a portion of the distribution network that feeds location(s) that have the refillable bulk dispensing containers. As an example, the ecological cost (including the carbon cost, the energy cost, etc.) of manufacturing each refillable bulk dispensing container at a location, the ecological cost of installing each refillable bulk dispensing container, and the ecological cost of refilling and/or maintaining each refillable bulk dispensing container at that location are all determined and rolled into a single predetermined ecological cost/value.

The comparison between the final amount and the predetermined ecological cost is to show the ecological cost of a specific bulk dispensing container implementation against how much ecological cost was avoided by using the bulk dispensing container system. Preferably, the ecological cost of implementing the specific bulk dispensing container system is lower, if not much lower, than the final amount calculated. Such a result would show that there is a net gain in terms of ecological cost-that, effectively, by using the specific bulk dispensing container system, less ecological cost was absorbed by the environment than by not implementing and using the bulk dispensing container system. The comparison and its results can then be executed and provided/shown to the user (step 340).

After the comparison, if there is a net gain in terms of ecological cost, depending on the implementation, this net gain may be monetized/taken advantage of. For some implementations, the net gain may simply be displayed/noted to the user. The user can then use the detailed net gain for marketing/promotional uses. However, for other implementations, the net gain may be monetized by having the system suitably interface with external servers/platforms that provide for a marketplace for carbon credits/ecological benefit credits. Such external servers/platforms are, of course, beyond the scope of the present invention. In another aspect, the present invention gathers data from a dispensing location relating to an amount of windshield washer fluid dispensed by the refillable bulk dispensing containers at the location. This amount of product dispensed is then correlated with a number of disposable or single use containers that would have been used for an equivalent amount of product. This number of disposable containers is then used to calculate the ecological cost of that number of disposable containers. This cost is then compared to the ecological cost for implementing the refillable bulk dispensing container(s). A net gain (an offset) after the comparison would show that the refillable bulk dispensing container system is quantifiably ecologically friendlier than the alternative.

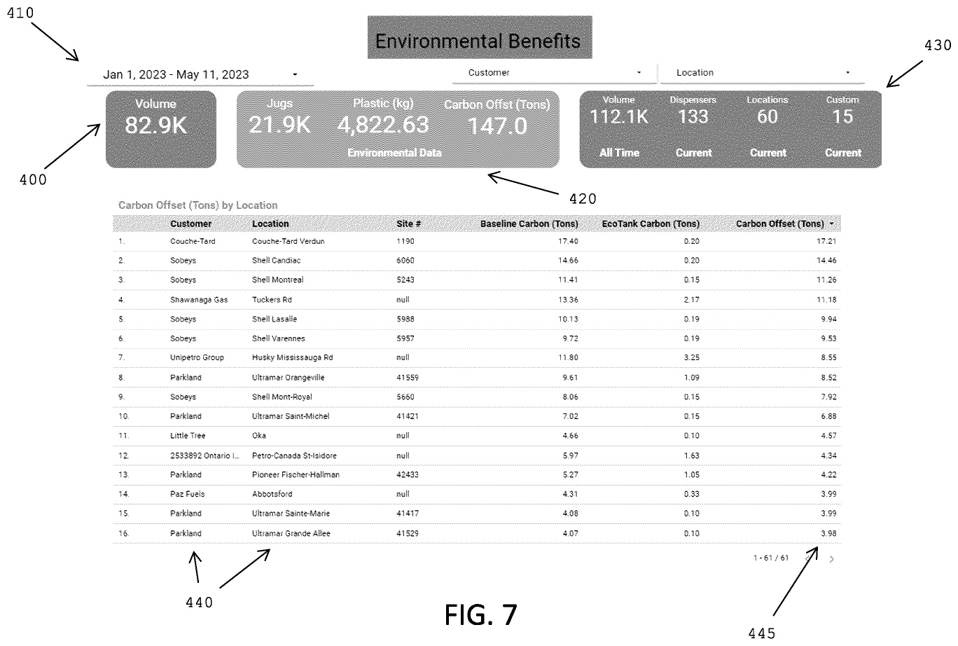

Referring to FIG. 7, a user interface for use with this aspect of the present invention is illustrated. As can be seen, the total volume of product dispensed 400 is shown. The time period/time frame 410 for the report is also shown. The total amount 420 of equivalent plastic (i.e. non-biodegradable material) that has been diverted or not used is shown along with the number of disposable containers that this amount is taken from as well as the resource offsets that this has generated (or ecological costs avoided). The number of bulk dispensing containers and the number of locations used to generate these resource offsets are also detailed in box 430. Also provided 440 are the customers, the locations, and the amount of resource offsets 445 for each location.

It should be clear that while the above description makes specific mention of windshield washer fluid as being the product dispensed by the bulk dispensing containers, the various aspects of the invention may be used with other products. Other products such as oil, gasoline, and other fluids may take advantage of the various aspects of the present invention. Similarly other non-fluid products (such as solids) may also be used with the invention. Products such as wheat, rice, other grains, powdered detergents, etc. may also be used with the various aspects of the present invention.

It should be clear that the various aspects of the present invention may be implemented as software modules in an overall software system. As such, the present invention may thus take the form of computer executable instructions that, when executed, implements various software modules with predefined functions.

Additionally, it should be clear that, unless otherwise specified, any references herein to ‘image’ or to ‘images’ refer to a digital image or to digital images, comprising pixels or picture cells. Likewise, any references to an ‘audio file’ or to ‘audio files’ refer to digital audio files, unless otherwise specified. ‘Video’, ‘video files’, ‘data objects’, ‘data files’ and all other such terms should be taken to mean digital files and/or data objects, unless otherwise specified.

The embodiments of the invention may be executed by a computer processor or similar device programmed in the manner of method steps or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A method for determining locations to be included in a refill trip for refilling fixed refillable bulk dispensing containers at said locations, the method comprising:
determining locations in a specific geographic area;
gathering data for said locations in said specific geographic area;
determining if specific locations conform to specific predetermined listing criteria;
in the event said specific locations conform to said specific predetermined listing criteria, including said specific locations in a refill list;
in the event said specific locations do not conform to said specific predetermined listing criteria, omitting said specific locations from said refill list;
determining routing criteria for use in determining a routing for said specific locations in said refill list;
determining said routing for said trip, said routing being based on at least one of:
a minimization of a first subset of said routing criteria;
a maximization of a second subset of said routing criteria;
wherein said routing includes refilling stops at a plurality of said specific locations in said refill list.

2. The method according to claim 1, wherein said specific predetermined listing criteria includes at least one of:
a fill level of refillable bulk dispensing containers being at or below a predetermined threshold;
a fill level of said refillable bulk dispensing containers indicating that said refillable bulk dispensing containers require a refill within a predetermined number of days based on a projected usage rate for a content of said refillable bulk dispensing containers;
a fill level of said refillable bulk dispensing containers indicating that said refillable bulk dispensing containers will be empty within a predetermined number of days based on a projected usage rate for a content of said refillable bulk dispensing containers.

3. The method according to claim 1, wherein said first subset of said routing criteria includes at least one of:
a cost of a refill vehicle driver;
a cost of fuel for a refill vehicle;
a distance travelled by a refill vehicle;
an amount of fuel used by said refill vehicle;
an amount of time taken to complete said refill trip;
a distance between locations visited for said refill trip;
time on the road between locations visited for a refill trip;
a cost per unit distance travelled by said refill vehicle;
a distance of a location from a starting point;
a distance of a location from other refillable bulk dispensing containers that are on said refill list;
an average time to refill a refillable bulk dispensing container;
a total time spent refilling refillable bulk dispensing containers on said refill trip.

4. The method according to claim 1, wherein said second subset of said routing criteria includes at least one of:
a number of locations visited in said refill trip;
a number of refillable bulk dispensing containers refilled;
an amount of fluid dispensed to refill said refillable bulk dispensing containers.

5. The method according to claim 1, further comprising mapping said routing for said refill trip is mapped and providing said mapping to a user.

6. The method according to claim 1, wherein said refillable bulk dispensing containers are refilled with windshield washer fluid.

7. The method according to claim 1, wherein said data for said locations includes at least one of:
usage/dispensing rates for said refillable bulk dispensing containers;
fill levels of said refillable bulk dispensing containers;
sales information of product dispensed through said refillable bulk dispensing containers.

8. A system for determining locations to be included in a refill trip for refilling fixed refillable bulk dispensing containers at said locations, the system comprising:
a data gathering module for gathering data relating to said refillable bulk dispensing containers at said locations;
a container parameter determination module for determining parameters relating to said refillable bulk dispensing containers, said parameters being based on said data;
a route inclusion module for determining if a specific location is to be included in a refill trip based on said data and on said parameters relating to refillable bulk dispensing containers at said specific location;
a route determination module for determining a route for said refill trip based on at least one of:
a minimization of a first subset of routing criteria;
a maximization of a second subset of said routing criteria.

9. The system according to claim 8, wherein locations are included in said refill trip based on at least one of:
a fill level of refillable bulk dispensing containers being at or below a predetermined threshold;
a fill level of said refillable bulk dispensing containers indicating that said refillable bulk dispensing containers require a refill within a predetermined number of days based on a projected usage rate for a content of said refillable bulk dispensing containers;
a fill level of said refillable bulk dispensing containers indicating that said refillable bulk dispensing containers will be empty within a predetermined number of days based on a projected usage rate for a content of said refillable bulk dispensing containers.

10. The system according to claim 8, wherein said first subset of said routing criteria includes at least one of:
a cost of a refill vehicle driver;
a cost of fuel for a refill vehicle;
a distance travelled by a refill vehicle;
an amount of fuel used by said refill vehicle;
an amount of time taken to complete said refill trip;
a distance between locations visited for said refill trip;
time on the road between locations visited for a refill trip;
a cost per unit distance travelled by said refill vehicle;
a distance of a location from a starting point;
a distance of a location from other refillable bulk dispensing containers that are on said refill list;
an average time to refill a refillable bulk dispensing container;
a total time spent refilling refillable bulk dispensing containers on said refill trip.

11. The system according to claim 8, wherein said second subset of said routing criteria includes at least one of:
a number of locations visited in said refill trip;
a number of refillable bulk dispensing containers refilled;
an amount of fluid dispensed to refill said refillable bulk dispensing containers.

12. A method for determining resource offsets based on an amount of product dispensed from refillable bulk dispensing containers, the method comprising:
gathering data relating to refillable bulk dispensing containers at specific locations;
determining parameters relating to said refillable bulk dispensing containers, said parameters being based on said data;
determining a number of disposable containers not used due to a use of said refillable bulk dispensing containers;
determining an amount of non-biodegradable material equivalent to said number of disposable containers;
determining an ecological cost for said amount of non-biodegradable material;
comparing said ecological cost for said amount of non-biodegradable material against an ecological cost for implementing said bulk dispensing containers that dispensed said product to result in a resource offset result;
presenting said resource offset result to a user;
wherein
said number of disposable containers is based on said amount of product dispensed from said refillable bulk dispensing containers over a predetermined amount of time, said amount of product dispensed being determined from said parameters.

13. The method according to claim 12, wherein said data is gathered from sensors coupled to said refillable bulk dispensing containers.

14. The method according to claim 12, wherein said data is gathered from point of sale terminals.

15. The method according to claim 14, wherein said data from said point of sale terminals are related to a volume of product dispensed from said refillable bulk dispensing containers.

16. The method according to claim 12, wherein said product is windshield washer fluid.

17. Non-transitory computer readable media having encoded thereon computer readable and computer executable instructions that, when executed, implements a method for determining locations to be included in a refill trip for refilling fixed refillable bulk dispensing containers at said locations, the method comprising:
determining locations in a specific geographic area;
gathering data for said locations in said specific geographic area;
determining if specific locations conform to specific predetermined listing criteria;
in the event said specific locations conform to said specific predetermined listing criteria, including said specific locations in a refill list;
in the event said specific locations do not conform to said specific predetermined listing criteria, omitting said specific locations from said refill list;
determining routing criteria for use in determining a routing for said specific locations in said refill list;
determining said routing for said trip, said routing being based on at least one of:
a minimization of a first subset of said routing criteria;
a maximization of a second subset of said routing criteria;
wherein said routing includes refilling stops at a plurality of said specific locations in said refill list.

18. Non-transitory computer readable media having encoded thereon computer readable and computer executable instructions that, when executed, implements a method for determining resource offsets based on an amount of product dispensed from refillable bulk dispensing containers, the method comprising:
gathering data relating to refillable bulk dispensing containers at specific locations;
determining parameters relating to said refillable bulk dispensing containers, said parameters being based on said data;
determining a number of disposable containers not used due to a use of said refillable bulk dispensing containers;
determining an amount of non-biodegradable material equivalent to said number of disposable containers;
determining an ecological cost for said amount of non-biodegradable material;
comparing said ecological cost for said amount of non-biodegradable material against an ecological cost for implementing said bulk dispensing containers that dispensed said product to result in a resource offset result;
presenting said resource offset result to a user;
wherein
said number of disposable containers is based on said amount of product dispensed from said refillable bulk dispensing containers over a predetermined amount of time, said amount of product dispensed being determined from said parameters.
